(19) United States
(12) Patent Application Publication
(10) Pub. No.: US 2021/0011209 A1
(43) Pub. Date: Jan. 14, 2021

(54) DOOR GLASS FOR VEHICLES

(71) Applicant: AGC Inc., Tokyo (JP)

(72) Inventors: Ryota NAKAMURA, Tokyo (JP); Tokihiko AOKI, Tokyo (JP)

(73) Assignee: AGC Inc., Tokyo (JP)

(21) Appl. No.: 17/032,772

(22) Filed: Sep. 25, 2020

Related U.S. Application Data
(63) Continuation of application No. PCT/JP2019/015920, filed on Apr. 12, 2019.

(30) Foreign Application Priority Data
Apr. 19, 2018 (JP) 2018-080602

(51) Int. Cl. G02B 5/28; B60J 1/08; B32B 17/10

(52) U.S. Cl. CPC G02B 5/282; B60J 1/08; B32B 17/10761; B32B 2605/006; B32B 17/10165; B32B 17/10036; B32B 17/10779

(57) ABSTRACT

A door glass for a vehicle includes a laminated glass having a first glass plate, a first adhesive layer, an infrared-reflective film, a second adhesive layer, and a second glass plate laminated in this order. The infrared-reflective film includes a laminate in which 100 or more layers of resin layers having different refractive indices are laminated, and has a thermal shrinkage rate of greater than 0.6% and less than 1.2% in a direction in which the thermal shrinkage rate becomes maximum, and in a direction perpendicular to the maximum direction. In an area where the laminated glass is visible when mounted on the vehicle, the outer periphery of the infrared-reflective film is positioned within a range of up to 10 mm inward from the outer periphery of the laminated glass in front view.

### CROSS-REFERENCE TO RELATED APPLICATIONS

This U.S. non-provisional application is a continuation application of and claims the benefit of priority under 35 U.S.C. § 365(c) from PCT International Application PCT/JP2019/015920 filed on Apr. 12, 2019, which is designated the U.S., and is based upon and claims the benefit of priority of Japanese Patent Application No. 2018-080602 filed on Apr. 19, 2018, the entire contents of which are incorporated herein by reference.

### TECHNICAL FIELD

The present invention relates to door glass for vehicles, in particular, door glass for vehicles made of laminated glass using an infrared-reflective film.

### BACKGROUND ART

Conventionally, in order to reduce the load of air conditioning of a vehicle and to improve the comfort of occupants, door glass for vehicles that uses laminated glass having heat insulation capability has been known. Among such glasses, a laminated glass that has an infrared-reflective film arranged between two plates of glasses via an adhesive layer has been proposed.

The laminated glass is manufactured by, for example, laminating a glass plate, an adhesive layer, an infrared-reflective film, another adhesive layer, and another glass plate in this order, and then, heating and pressing the entire laminate to be integrated. When manufacturing such a laminated glass, there have been problems such that, due to uneven pressing caused by unevenness in the thickness of the adhesive layers and/or a difference in the thermal shrinkage rate between the film and the adhesive layers, uneven distortions and/or wrinkles occur on the film, and thereby, the appearance becomes degraded; and measures to solve these problems have been studied.

For example, WO2013-137288 (Patent Document 1) discloses a technique of a multilayer laminate film that has a function of reflecting infrared rays by interference reflection, in which the thermal shrinkage stress of the film is specified so as to suppress the unevenness in the appearance, by alternately laminating resin layers having different refractive indices, and controlling the thickness of each layer to be laminated.

Also, Japanese Laid-Open Patent Application No. 2010-180089 (Patent Document 2) discloses a laminated glass in which one of the thermal shrinkage rate, the modulus of elasticity, and the elongation of the infrared-reflective film is controlled so that one of the properties falls within a predetermined range, in order to suppress wrinkles on the film, which tend to occur in peripheral parts of the principal surfaces, particularly in the case of using glass plates curved by bending.

Here, the techniques of Patent Document 1 and Patent Document 2 have an object to prevent degradation in the appearance within the principal surfaces of a laminated glass, and are effective to a certain extent. However, in the case of door glass for vehicles, it has been known that the peripheral parts and end surfaces of the principal surfaces (hereafter, referred to as the end parts) are particularly conspicuous when the door glass is moved up or down, and the appearance of the end parts poses a problem.

For example, in order to protect the end parts of the infrared-reflective film, in some cases, the outer periphery of the film is arranged inward relative to the outer periphery of the glass plate in plan view. In this case, a problem arises especially when the door glass is moved up or down, that the color tone of the end parts of the door glass changes and appears to be shimmering. On the other hand, in the case of arranging the outer periphery of the film close to the outer periphery of the glass plates in plan view in order to improve the appearance, another problem arises that the infrared-reflective film is thermally shrunk due to heating in the manufacturing process, which causes the adhesive layers to be drawn toward the center of the principal surfaces, and thereby, causes degradation in the appearance at the end parts of the glass.

However, as described above, in Patent Document 1 and Patent Document 2, degradation in the appearance is suppressed on the principal surfaces of the laminated glass caused by the infrared-reflective film; however, the problem of the shimmer at the end parts in the case of using the glass as the door glass of a vehicle, and the appearance problem caused by the drawing of the adhesive layers are not solved.

### SUMMARY

According to an embodiment of the present invention, a door glass for a vehicle includes a laminated glass having a first glass plate, a first adhesive layer, an infrared-reflective film, a second adhesive layer, and a second glass plate laminated in this order. The infrared-reflective film includes a laminate in which 100 or more layers of resin layers having different refractive indices are laminated, and has a thermal shrinkage rate of greater than 0.6% and less than 1.2% in a direction in which the thermal shrinkage rate becomes maximum, and a thermal shrinkage rate of greater than 0.6% and less than 1.2% in a direction perpendicular to the direction in which the thermal shrinkage rate becomes maximum. The thermal shrinkage rate of the infrared-reflective film in a predetermined direction is a shrinkage rate of a length in the predetermined direction before and after holding the infrared-reflective film at 150° C. for 30 minutes. In an area where the laminated glass is visible when the laminated glass is mounted on the vehicle, the outer periphery of the infrared-reflective film is positioned within a range of up to 10 mm inward from the outer periphery of the laminated glass in front view.

### BRIEF DESCRIPTION OF DRAWINGS

FIG. 1 is an example of a front view of a laminated glass constituting door glass for vehicles in an embodiment according to the present invention;

FIG. 2 is a cross-sectional view of the laminated glass illustrated in FIG. 1 along a line X-X; and

FIG. 3 is a side view of an automobile that includes the door glass for vehicles illustrated in FIG. 1.

### EMBODIMENTS OF THE INVENTION

In the following, embodiments according to the present invention will be described.

Note that the present invention is not limited to these embodiments, and these embodiments can be altered or modified without deviating from the gist and scope of the present invention.

According to the present invention, it is possible to provide door glass for vehicles made of a laminated glass using an infrared-reflective film, which is excellent in heat insulation, and has a good appearance, with which occurrences of degraded appearance is suppressed particularly at the end parts.

Note that although a laminated glass using an infrared-reflective film has been also known for the so-called orange peel problem, which is a phenomenon where the outline of a reflected image looks swaying, according to the present invention, occurrences of the orange peel can also be suppressed.

A door glass for vehicles (hereafter, simply referred to as the “door glass”) according to an embodiment includes a first glass plate, a first adhesive layer, an infrared-reflective film, a second adhesive layer, and a second glass plate, which are laminated in this order to form a laminated glass, wherein the configuration of the infrared-reflective film satisfies the following requirements (1) to (3).

(1) The infrared-reflective film includes a laminate in which 100 or more layers of resin layers having different refractive indices are laminated.
(2) The infrared-reflective film has a thermal shrinkage rate of greater than 0.6% and less than 1.2% in a direction in which the thermal shrinkage rate becomes maximum, and a thermal shrinkage rate of greater than 0.6% and less than 1.2% in a direction perpendicular to the maximum direction. Here, the thermal shrinkage rate of an infrared-reflective film in a predetermined direction is a shrinkage rate of the length in the predetermined direction before and after holding the infrared-reflective film at 150° C. for 30 minutes.
(3) In an area where the laminated glass is visible when the laminated glass is mounted on a vehicle, the outer periphery of the infrared-reflective film is positioned within a range of up to 10 mm inward from the outer periphery of the laminated glass in front view.

An infrared-reflective film that satisfies the requirement of (1) has infrared reflectivity caused by interference reflection. In an infrared-reflective film that satisfies the requirement of (2), drawing of the adhesive layers when manufacturing the laminated glass can be suppressed, and in an infrared-reflective film that satisfies the requirement of (3), the shimmer when formed as the laminated glass can be suppressed, and the degraded appearance at the end parts can be suppressed. Thus, it is possible to obtain a door glass that is excellent in heat insulation, and has a good appearance, in which the occurrence of degraded appearance particularly at the end parts is suppressed. In the following, the door glass according to the embodiment will be described with reference to the drawings.

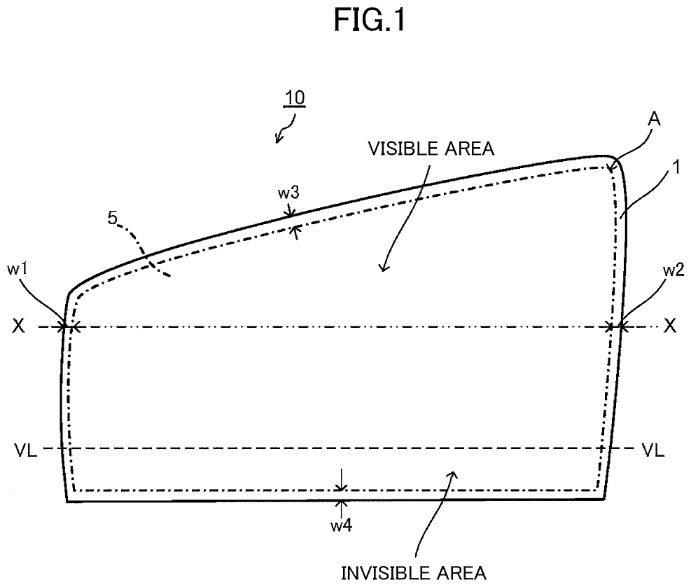

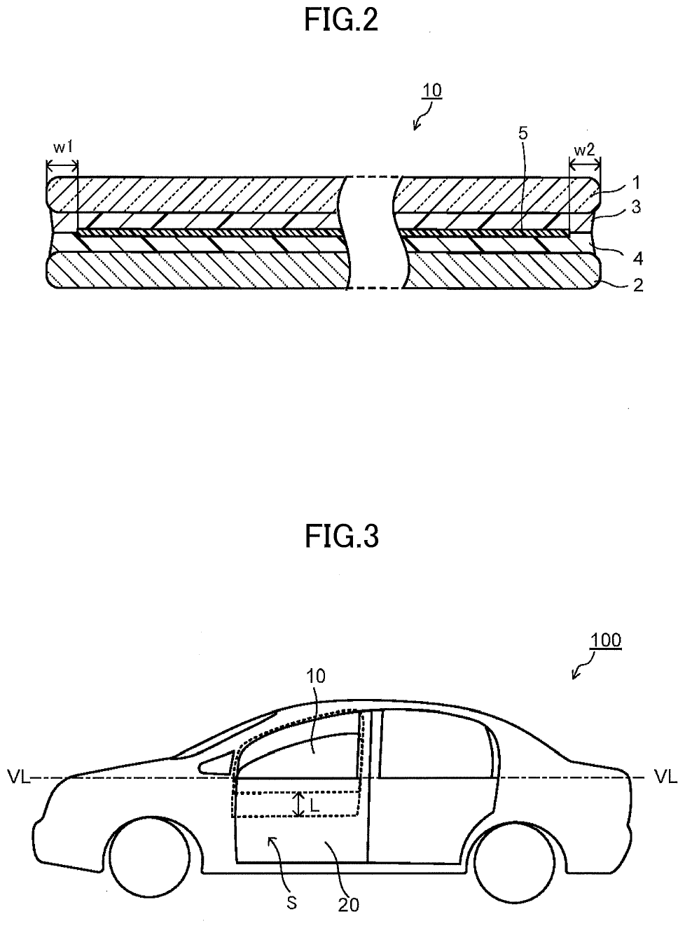

FIG. 1 is a front view of a laminated glass constituting a door glass for vehicles according to an embodiment; FIG. 2 is a cross-sectional view of the laminated glass illustrated in FIG. 1 along a line X-X; and FIG. 3 is a side view of an automobile that includes a door glass as an example of the embodiment illustrated in FIG. 1.

In the present description, “upper”, “lower”, “front”, and “rear” refer to the upper, lower, front, and rear sides, respectively, of the door glass when the door glass is mounted on the vehicle. The “vertical direction” of the door glass indicates the vertical direction with respect to the door glass when the door glass is mounted on the vehicle, and the direction orthogonal to the vertical direction is referred to as the “vehicle width direction”.

In the present description, each of the first glass plate, the first adhesive layer, the infrared-reflective film, the second adhesive layer, and the second glass plate; and the door glass has two principal surfaces facing each other, and has end surfaces that connect the two principal surfaces. In the present description, a peripheral part of a principal surface refers to an area that has a certain width from the outer periphery toward the center of the principal surface. The peripheral parts and the end surfaces of both principal surfaces are referred to as the end parts. Also, in the present description, the outer peripheral part viewed from the center of the principal surface is referred to as the outside, and the center part viewed from the outer peripheral part of the principal surface is referred to as the inside. In the present description, “substantially the same shape” and “the same dimensions” refer to a state of an object that can be considered to have the same shape and the same dimensions when viewed by a person. In other cases, “substantially” has a similar meaning as above. Also, a numerical range expressed with “to” includes an upper limit and a lower limit.

A laminated glass 10 used as the door glass illustrated in FIGS. 1 and 2 (hereafter, also referred to as the “door glass 10”) includes a first glass plate 1, a first adhesive layer 3, an infrared-reflective film 5, a second adhesive layer 4, and a second glass plate 2 that are laminated in this order. The first glass plate 1, the first adhesive layer 3, the second adhesive layer 4, and the second glass plate 2 have principle surfaces of substantially the same shape and the same dimensions as each other.

In the laminated glass 10, the shape of the principal surfaces of the infrared-reflective film 5 is substantially similar to the shape of the principal surfaces of the first glass plate 1. In an area where the laminated glass 10 is visible in front view when the laminated glass 10 is mounted on the vehicle (hereafter, referred to as the “visible area”), the infrared-reflective film 5 has its outer periphery (designated by a single dotted line in FIG. 1) positioned within a range of up to 10 mm inward from the outer periphery of the laminated glass 10 in front view.

An automobile 100 illustrated in FIG. 3 includes the laminated glass 10 illustrated in FIG. 1. In the automobile 100, each of the front side door S and the rear side door S includes a door panel 20 and the door glass 10 that is installed in the door panel 20 and can be moved up and down. In FIG. 3, when the door glass 10 is moved up to the top of the front side door S, namely, when the window is closed, the door glass 10 is designated with a dashed line. Also, when the door glass 10 is moved down by a distance L from the topmost position, the door glass 10 is designated with a solid line and a dashed line,

In the automobile 100, a line connecting the upper ends at the front and rear of the door panel 20, namely, a line connecting the lower ends of an opening of the vehicle is referred to as a belt line VL. FIG. 1 illustrates a position of the belt line VL across the door glass 10 when the door glass 10 mounted on the automobile 100 is moved up to the top (when the door glass is completely closed). In the present description, in the door glass 10, the visible area is, as illustrated in FIG. 1, an area positioned above the belt line VL in a state where the door glass 10 is mounted on the automobile 100, and the door glass 10 is moved up to the top. An area positioned below the belt line VL in the state is an invisible area.

FIG. 3 illustrates that no end surface of the door glass 10 is visible in a state where the window is closed, whereas part of the end surfaces becomes visible by opening the window. In the door glass 10, at least, in a state where the door glass 10 is mounted on the automobile 100, and the door glass 10 is moved up to the top, if the requirement of (3) above is satisfied, the shimmer can be suppressed in an area positioned above the belt line VL. In the following, the components of the door glass 10 will be described.

### [Infrared-Reflective Film]

The infrared-reflective film 5 in the door glass 10 satisfies the requirements of (1) to (3) above. It is further favorable that the infrared-reflective film 5 also satisfies one or both of the following requirements (4) and (5).

(4) The infrared-reflective film has a thickness of less than or equal to 120 μm
(5) The infrared-reflective film has a minimum radius of curvature of greater than or equal to 8 mm in front view, in an area where the laminated glass is visible when the laminated glass is mounted on the vehicle.

By satisfying the requirement of (1), the infrared-reflective film includes a laminate in which 100 or more layers of resin layers having different refractive indices are laminated. By including the laminate, the infrared-reflective film 5 has infrared reflectivity. The infrared-reflective film 5 may be constituted with only the laminate, or may optionally include another layer, for example, a protective layer or the like, which will be described later, as long as the effects of the present invention are not impaired. The other layer in the infrared-reflective film is favorably made of resin from the viewpoint of durability.

As for the requirement of (1), in the infrared-reflective film 5, the number of types of resin layers, which constitute the laminate and have different refractive indices, may be greater than or equal to two types, favorably greater than or equal to two types and less than or equal to four types, and particularly favorably two types from the viewpoint of ease of manufacturing. In the case of using two types of resin layers having different refractive indices, a resin layer having a relatively higher refractive index is defined as the higher-refractive-index layer, and a resin layer having a relatively lower refractive index is defined as the lower-refractive-index layer. In this case, the laminate is normally formed by alternately laminating the higher-refractive-index layer and the lower-refractive-index layer.

The refractive index in the resin layer is given as a refractive index at a wavelength of 589 nm that is measured using a sodium D line as the light source. The refractive index of the higher-refractive-index layer is favorably within a range of 1.62 to 1.70, and the refractive index of the lower-refractive-index layer is favorably within a range of 1.50 to 1.58. Also, the difference in the refractive index between the higher-refractive-index layer and the lower-refractive-index layer is favorably within a range of 0.05 to 0.20, and more favorably within a range of 0.10 to 0.15.

The refractive index of a resin layer can be adjusted by appropriately adjusting the type of resin, the type of functional group or skeleton in the resin, and the content of the resin. As the resin forming a resin layer, a thermoplastic resin is favorable, and, for example, polyolefin, alicyclic polyolefin, polyamide, aramid, acrylic resin, polyvinyl chloride, polyvinylidene chloride, polystyrene, styrene copolymer, polycarbonate, polyester, polyether sulfone, polyether ether ketone, modified polyphenylene ether, polyphenylene sulfide, polyetherimide, polyimide, polyarylate, fluorine-containing resin, and the like may be listed.

From among these resins, two or more types of resins having different refractive indices are selected, and resin layers formed of the selected resins are laminated according to the design described above to form a laminate. Note that when selecting resins having different refractive indices, from the viewpoint of inter-layer adhesion and feasibility of forming a laminate structure with high precision, it is favorable to select a combination of resins including the same repeating units. Among the resins described above, polyester is favorable from the viewpoint of strength, heat resistance, and transparency, and it is favorable that a combination is selected from among polyesters that include the same repeating units. As the polyester to be selected, a polyester obtained by using an aromatic dicarboxylic acid, an aliphatic dicarboxylic acid, a diol, or a derivative of these is favorable.

As the polyester to be selected, polyethylene terephthalate, polyethylene terephthalate copolymer, polyethylene naphthalate, polyethylene naphthalate copolymer, polybutylene terephthalate, polybutylene terephthalate copolymer, polybutylene naphthalate, polybutylene naphthalate copolymer, polyhexamethylene terephthalate, polyhexamethylene terephthalate copolymer, polyhexamethylene naphthalate, polyhexamethylene naphthalate copolymer, and the like may be listed. It is favorable to use one or more type of polyesters selected from among the polyesters described above.

Among these, as the resins forming resin layers having different refractive indices, a combination that includes at least one type selected from among a polyethylene terephthalate (hereafter, referred to as a “PET”) and a polyethylene terephthalate copolymer (hereafter, referred to as a “PET copolymer”) is favorable. In the case of forming a laminate by alternately laminating two types of resin layers, it is favorable that, for example, one is a resin layer made of a PET, and the other is a resin layer made of a PET copolymer or a resin layer constituted with at least two types of resins selected from among PET and PET copolymers (hereafter, referred to as “mixed PET”).

A PET copolymer is constituted with ethylene terephthalate units, which are the same repeating units as a PET, and repeating units having other ester bonds (hereafter, referred to as “the other repeating units”). As the ratio of the other repeating units (hereafter, referred to as the “amount of copolymerization”), it is favorable that the ratio is greater than or equal to 5 mol % in view of the necessity of obtaining a different refractive index, and less than or equal to 90 mol % in view of the adhesion between layers, and the excellent precision and uniformity of the thickness of each layer thanks to a small difference in the thermal flow characteristics. The ratio is further favorably greater than or equal to 10 mol % and less than or equal to 80 mol %.

Note that in the case where a mixed PET is a mixture of a PET and a PET copolymer, or a mixture of two or more types of PET copolymers, it is favorable to mix the components so that the content of the other repeating units in the mixture is substantially the same as the amount of copolymer in the PET copolymer.

It is favorable that the absolute value of the difference in the glass transition temperature between the resin layers having different refractive indices is less than or equal to 20° C. In the case where the absolute value of the difference in the glass transition temperature is higher than 20° C., the uniformity of the thickness when forming an infrared-reflective film including the laminate becomes inadequate, and variation in the infrared reflectivity may occur. Also, when molding an infrared-reflective film including the laminate, a problem such as excessive stretching is likely to occur.

It is favorable that a mixed PET includes, as the other repeating units, repeating units derived from spiroglycol being a diol as the raw material. In the following, a repeating unit derived from a raw material component is denoted by the name of the raw material compound suffixed with “unit”. For example, a repeating unit derived from spiroglycol is denoted as “spiroglycol unit”. A mixed PET containing spiroglycol units means that the mixed PET containing a PET copolymer containing the spiroglycol units. A mixed PET may be constituted with only a PET copolymer having spiroglycol units, or may be a mixture of the PET copolymer and a PET. In the following description, a mixed PET containing units of a particular compound means the same as in the case of a mixed PET containing the spiroglycol units. A mixed PET containing spiroglycol units is favorable because of a small difference in the glass transition temperature with a PET.

It is favorable that a mixed PET contains, as the other repeating units, cyclohexanedicarboxylic acid units in addition to spiroglycol units. A mixed PET containing spiroglycol units and cyclohexanedicarboxylic acid units has a small difference in the glass transition temperature with a PET and a large difference in the refractive index with a PET, and thereby, is likely to exhibit high infrared reflectivity when used in the laminate.

In the case where a mixed PET contains spiroglycol units and cyclohexanedicarboxylic acid units, it is favorable that the amount of copolymerization of the spiroglycol units is 5 mol % to 30 mol %, and the amount of copolymerization of the cyclohexanedicarboxylic acid units is 5 mol % to 30 mol %.

A form of a mixed PET that contains cyclohexanedimethanol units as the other repeating units is also favorable. A mixed PET containing cyclohexanedimethanol units is favorable because of a small difference in the glass transition temperature with a PET.

In the case where a mixed PET contains cyclohexanedimethanol units, the amount of copolymerization of cyclohexanedimethanol units is favorably greater than or equal to 15 mol % and less than or equal to 60 mol % from the viewpoint of compatibility between the infrared reflectivity and the inter-layer adhesion. Note that isomers of cyclohexanedimethanol include the cis isomer and the trans isomer as the geometrical isomers, and the chair conformation and the boat conformation as the conformational isomers. Therefore, a mixed PET containing cyclohexanedimethanol units does not tend to become oriented crystals even when being stretched with a PET; has high infrared reflectivity; is less likely to change in optical properties that would be caused by thermal history; and is less likely to generate defects during film formation.

The intrinsic viscosity (IV) of a PET and a mixed PET used as above is favorably 0.4 to 0.8, and more favorably 0.6 to 0.75, from the viewpoint of stability of film formation.

As above, combinations of PETs and mixed PETs have been described. In the present invention, combinations are not limited to those described above, and depending on the desired characteristics, different mixed PETs may be combined. In such a case, it is favorable that the types of units constituting the mixed PETs are the same, and the compositions of the repeating units are different.

By laminating 100 or more resin layers having different refractive indices as such, the laminate comes to have a function of reflecting infrared rays by interference reflection. The number of laminated layers in the laminate is not limited in particular as long as it is greater than or equal to 100 layers. It is favorable to properly adjust the number within a range where the film thickness of the infrared-reflective film 5 satisfies the requirement of (4). In order to improve the infrared reflectivity, the number of resin layers is favorably 400 or more layers, and more favorably 600 or more layers. The upper limit of the number of laminated layers in the laminate is favorably approximately 5000 layers from the viewpoint of satisfying the favorable upper limit of the thickness of the infrared-reflective film 5.

The number of laminated layers of resin layers and the thickness of each resin layer included in the laminate are designed based on the refractive index of each resin layer to be used, and depending on the required infrared reflectivity. For example, in the case of using a layer A and a layer B as two resin layers having different refractive indices, in terms of distribution of the thickness, it is favorable that the optical thicknesses of the layer A and layer B adjacent to each other satisfy the following formula (i):

Δ=2(n_{A}d_{A}+n_{B}d_{B}) (i)

where λrepresents the reflected wavelength; n_{A} represents the refractive index of the layer A; d_{A} represents the thickness of the layer A; n_{B} represents the refractive index of the layer B; and d_{B} represents the thickness of the layer B.

It is also favorable that the distribution of the layer thickness satisfies the following formula (ii) at the same time with the formula (i).

n_{A}d_{A}=n_{B}d_{B} (ii)

By having a distribution of the layer thickness that satisfies (i) and (ii) at the same time, even-ordered reflections can be eliminated. Thus, for example, it is possible to increase the average reflectance at wavelengths from 850 nm to 1200 nm while lowering the average reflectance at wavelengths from 400 nm to 700 nm. and hence, it is possible to obtain an infrared-reflective film 5 that is transparent and has high insulation performance with respect to thermal energy.

It is also favorable to use a configuration of 711711 (U.S. Pat. No. 5,360,659) as the distribution of the layer thickness in addition to the formulas (i) and (ii). The configuration of 711711 is a configuration of a laminate in which six layers of layers A and layers B laminated in the order of ABABAB constitute a repeating unit, and the ratios of the optical thicknesses in the unit are set to 711711. A distribution of the layer thickness according to the configuration of 711711 eliminates higher-order reflections. Thus, for example, it is possible to increase the average reflectance at wavelengths from 850 nm to 1400 nm while lowering the average reflectance at wavelengths from 400 nm to 700 nm. Also, it is also favorable to have a distribution of the layer thickness in which a distribution of the layer thickness that satisfies both formulas (i) and (ii) at the same time is adopted for reflection within a range of 850 nm to 1200 nm; and a distribution of the layer thickness of the configuration of 711711 is adopted for reflection within a range of 1200 nm to 1400. By adopting such a configuration of the layer thickness, it is possible to efficiently reflect light with a smaller number of laminated layers.

As the distribution of the layer thickness, a distribution of the layer thickness in which the layer thickness is increased or decreased from one surface to the other surface of the film; a distribution of the layer thickness in which the layer thickness is increased from one surface toward the film center of the film, and then, decreased; a distribution of the layer thickness in which the layer thickness is decreased from one surface toward the film center of the film, and then, increased; or the like is favorable. As the way to change the layer thickness in a distribution, it is favorable to be a consecutive change, which may be a linear, geometric, or difference sequence; or a change in which 10 layers to 50 layers have virtually the same thickness, and this thickness changes stepwise.

Note that the infrared-reflective film 5 may have a resin layer having a layer thickness of greater than or equal to 3 μm as a protective layer on both surfaces of the laminate. The layer thickness of the protective layer is favorably greater than or equal to 5 μm, and more favorably greater than or equal to 10 μm. By thickening the layer thickness of the protective layer, it is possible to obtain an effect of suppressing flow marks, and suppressing ripples of the transmittance and the reflectance spectrum.

As for the requirement of (4), it is favorable that the infrared-reflective film 5 has a thickness of less than or equal to 120 μm. If the infrared-reflective film 5 has a thickness of less than or equal to 120 μm, the degassing performance when manufacturing the laminated glass is good. Also, it is favorable that the infrared-reflective film 5 has a thickness of greater than or equal to 80 μm. The infrared-reflective film 5 having a thickness of greater than or equal to 80 μm comes to have rigidity, which makes it less susceptible to the effect of thermal shrinkage of the first adhesive layer and second adhesive layer when manufacturing the laminated glass. Thus, for example, this makes it easier to suppress, for example, occurrences of orange peel. The thickness of the infrared-reflective film 5 is favorably greater than or equal to 85 μm and less than or equal to 115 μm, and more favorably greater than or equal to 90 μm and less than or equal to 110 μm.

As for the requirement of (2), the infrared-reflective film 5 has a thermal shrinkage rate of greater than 0.6% and less than 1.2% in a direction in which the thermal shrinkage rate becomes maximum (hereafter, referred to as the “maximum shrinkage direction”), and a thermal shrinkage rate of greater than 0.6% and less than 1.2% in a direction perpendicular to the maximum direction (hereafter, simply referred to as the “orthogonal direction”).

However, the thermal shrinkage rate of an infrared-reflective film is a shrinkage rate of the length in a predetermined direction before and after holding the infrared-reflective film at 150° C. for 30 minutes; specifically, the thermal shrinkage rate of an infrared-reflective film can be measured as follows.

First, a strip-shaped test piece is cut from the infrared-reflective film 5 along the maximum shrinkage direction or the orthogonal direction. An infrared-reflective film is manufactured by stretching the constituent material into a film shape as will be described later; therefore, the stress is present in the infrared-reflective film as residual stress. In particular, the residual stress is greater and the film tends to thermally shrink in the longitudinal direction, or the so-called MD direction, which is the flow direction when manufacturing the film. Therefore, normally, the MD direction corresponds to the maximum shrinkage direction, and the TD direction as the width direction corresponds to the orthogonal direction.

The test piece has dimensions of, for example, 150 mm in length and 20 mm in width. A pair of reference lines having a spacing of approximately 100 mm are written on the test piece in the longitudinal direction, and a length L₁ between the reference lines is measured. The test piece is suspended vertically in a hot-air circulating oven, heated up to 150° C., held for 30 minutes, cooled down naturally to room temperature, held for 60 minutes, and then, a length L₂ between the reference lines is measured. The thermal shrinkage rate can be calculated using the obtained L₁ and L₂ according to the following formula (iii).

thermal shrinkage rate=((L₁−L₂)/L₁)×100[%] (iii)

In an infrared-reflective film 5 having a thermal shrinkage rate exceeding 0.6% in the maximum shrinkage direction and in the orthogonal direction, it is possible to suppress the occurrence of orange peel, and having a thermal shrinkage rate of less than 1.2%, it is possible to suppress the occurrence of degraded appearance due to the drawing of the adhesive layers. The thermal shrinkage rate in the maximum shrinkage direction is favorably greater than or equal to 0.65% and less than or equal to 1.10%, and more favorably greater than or equal to 0.70% and less than or equal to 0.90%. The thermal shrinkage rate in the orthogonal direction is favorably greater than or equal to 0.65% and less than or equal to 1.10%, and more favorably greater than or equal to 0.70% and less than or equal to 1.10%. Also, it is favorable that the difference between the thermal shrinkage rate in the maximum shrinkage direction and the thermal shrinkage rate in the orthogonal direction is smaller, and it is particularly favorable that the thermal shrinkage rates are the same as each other.

An infrared-reflective film 5 that satisfies the requirements (1) and (2) and favorably satisfies the requirement of (4) can be manufactured, for example, by the following method. Note that the following example is a method of manufacturing an infrared-reflective film 5, which is made of a laminate that uses, as two types of resin layers having different refractive indices, a layer A made of a resin A and a layer B made of a resin B. It is possible to manufacture an infrared-reflective film using three or more types of resin layers, or an infrared-reflective film having another layer such as a protective layer, by changing the method appropriately.

An infrared-reflective film constituted with a laminate using the layer A and the layer B can be manufactured by a method that includes the following Steps (a) to (c). In the case where an infrared-reflective film that satisfies all of the requirements of (1) and (2) described above are obtained by Step (a) and Step (b), Step (c) is not performed. In other words, Step (c) can be treated as an optional step.

(a) Step of producing an unstretched laminate in which the layer A and the layer B are alternately laminated, wherein the unstretched laminate has the same number of laminated layers as in a laminate to be obtained finally, although the layer thickness differs from the final laminate.
(b) Step of stretching the unstretched laminate obtained at Step (a), and adjusting the layer thickness to produce a laminate precursor.
(c) Step of applying heat treatment to the laminate precursor after Step (b) to obtain a laminate whose thermal shrinkage rate is adjusted to satisfy the requirement of (2).

### (a) Step of Producing an Unstretched Laminate

The resin A and the resin B are prepared in the form of pellets or the like. The pellets are dried in advance in hot air or in a vacuum if necessary, and fed to extruders. In each extruder, the resin is heated beyond the melting point to be melt, extruded by a uniform amount by a gear pump or the like, and foreign substances or modified resin are removed through a filter or the like.

The resin A and the resin B discharged from different flow channels using two or more extruders are then conveyed to a multilayer laminating device, formed to be a molten laminate laminated to have the desired number of laminated layers by the multilayer laminating device, and then, shaped to have a desired shape using a die to be discharged. A sheet laminated to have the multiple layers and discharged from the die is extruded onto a cooling body, such as a casting drum, cooled and solidified, to become an unstretched laminate. Note that as the multilayer laminating device, a multi-manifold die, a field block, a static mixer, or the like can be used.

### (b) Stretching Step

The unstretched laminate obtained at Step (a) is stretched to produce a laminate precursor. The method of stretching is normally biaxial stretching. The method of biaxial stretching may be either of sequential biaxial stretching or simultaneous biaxial stretching. Further, stretching may be performed again in the MD direction and/or in the TD direction. From the viewpoint of suppressing the orientation difference in the surface and suppressing the surface scratches, simultaneous biaxial stretching is favorable. It is favorable to perform the biaxial stretching within a temperature range that is greater than or equal to a higher glass transition temperature among the glass transition temperatures of the resin A and of the resin B, and less than or equal to the higher glass transition temperature+120° C.

The respective stretching factors in the MD direction and in the TD direction are adjusted so that each layer has the designed layer thickness in the laminate to be obtained. Further, favorably, the stretching factors and the stretching speed are adjusted so that the residual stress in the MD direction becomes equivalent to that in the TD direction. Thus, a laminate precursor is obtained that satisfies the requirement of (1) in the infrared-reflective film to be obtained, and favorably satisfies the requirement of (4).

The laminate precursor obtained in the stretching step has high residual stress normally, and does not satisfy the requirement of (2) for the infrared-reflective film. Next, by applying the following heat treatment (c), it is possible to obtain a laminate that satisfies the requirement of (2). However, in the case where the laminate precursor satisfies the requirement of (2) as described above, the laminate precursor may be used as the laminate as it is.

### (c) Heat Treatment Step

Heat treatment of the laminate precursor is normally carried out in a stretching machine. The heat treatment temperature is favorably a temperature that is lower than a higher melting point among the melting points of the resin A and the resin B, and is higher than a lower melting point among the melting points of the resins. Thus, a resin having the higher melting point maintains a highly oriented state, whereas the orientation in a resin having the lower melting point is relaxed; therefore, it is easy to provide a difference between the refractive indices for these resins. Further, the relaxation of the orientation makes it easier to reduce the stress caused by thermal shrinkage. Therefore, the thermal shrinkage rate of the laminate can be easily adjusted to fall within the range of (2).

Note that the heat treatment may be performed so that the relaxation rate during the heat treatment is greater than or equal to 0% and less than or equal to 10%, and favorably greater than or equal to 0% and less than or equal to 5%. The relaxation may be performed in one or both of the TD direction and the MD direction. Also, it is also favorable to perform fine stretching with a rate of greater than or equal to 2% and less than or equal to 10% during the heat treatment. The fine stretching may be performed in one or both of the TD direction and the MD direction. In this way, the heat treatment temperature, the heat treatment time, the relaxation rate, and the fine stretching rate are adjusted to adjust the thermal shrinkage rate of the laminate to fall within the range of (2).

Note that for the purpose of adjusting the thermal shrinkage rate of the laminate, relaxation may be performed during cooling after the heat treatment step, and further, fine stretching may also be performed after the heat treatment step.

In the door glass 10, the infrared-reflective film 5 is arranged such that its maximum shrinkage direction virtually corresponds to the vertical direction or the vehicle width direction of the door glass 10. In this case, “virtually correspond” means that the difference between the angles is within ±5°.

The requirement of (3) for the infrared-reflective film 5 is a requirement for the position of the outer periphery of the infrared-reflective film 5 in the visible area of the laminated glass 10 in front view. In the following, unless otherwise noted, the visible area is a visible area in the case of viewing the laminated glass 10 in front view. The same applies to the nonvisible area. If the infrared-reflective film 5 satisfies the requirement of (3), namely, if the distance between the outer periphery of the infrared-reflective film 5 and the outer periphery of the laminated glass 10 is within 10 mm in the visible area, the shimmer at the end parts of the laminated glass 10 can be suppressed.

Note that the outer periphery of the laminated glass 10 in front view is normally corresponds to the outer periphery of the first glass plate 1 and the second glass plate 2 in front view.

The distance between the outer periphery of the infrared-reflective film 5 and the outer periphery of the laminated glass 10 in the visible area simply needs to be set so that the maximum value is less than or equal to 10 mm. In the following, the distance between the outer periphery of the infrared-reflective film 5 and the outer periphery of the laminated glass 10 (the end surface of the glass plate) in the visible area is denoted as the “distance W”. Note that in the case where the positions of the outer peripheries of the first glass plate and the second glass plate are different, the outer periphery located at outer positions is treated as the outer periphery of the glass plates. For example, as long as the maximum value of the distance W is within 10 mm, the distance W may vary on the left side (front side), right side (rear side), and upper side of the laminated glass 10 above the belt line VL as the visible area, or may vary along each of the sides. In FIG. 1, a distance w1 on the left side, a distance w2 on the right side, and a distance w3 on the upper side of the visible area are set to be the same, above the belt line VL.

Here, the primary cause of the shimmer is considered that the end surfaces of the infrared-reflective film 5 are visually recognized. As illustrated in FIG. 3, when the window is closed, none of the end surfaces of the door glass 10 is visible; however, in the case of the distance W exceeding 0, depending on the type of vehicle, the outer periphery of the infrared-reflective film 5 may be visible in front view. In this case, depending on the viewing angle, the end surfaces of the infrared-reflective film 5 may be visible especially on the left side (front side). Further, when the door glass 10 is moved up and down, the end surfaces of the infrared-reflective film 5 becomes easily visible, especially on the upper side.

However, in either of the above cases, if the distance W is less than 10 mm at its maximum, the shimmer at the end parts of the laminated glass can be sufficiently suppressed. The maximum value of the distance W is favorably set to be less than or equal to 5 mm, more favorably less than or equal to 3 mm, even more favorably less than or equal to 1.5 mm, and particularly favorably 0 mm. Also, depending on the type of vehicle, when the window is closed or the door glass 10 is moved up or down, especially for a side along which the end surface of the infrared-reflective film 5 becomes easily visible, measures such as shortening the distance W may be taken.

Note that in the laminated glass 10, the infrared-reflective film 5 is made of resin; therefore, even when the distance W is 0 mm, there is almost no effect of being exposed to the open air, and hence, the durability can be secured. Also, in the infrared-reflective film 5 that satisfies the requirement of (2), even if the distance W is 0 mm, the degraded appearance that would be caused by drawing of the adhesive layers while manufacturing the laminated glass hardly occurs.

In the invisible area of the laminated glass 10, the distance between the outer periphery of the infrared-reflective film 5 and the outer periphery of the laminated glass 10 is not limited in particular. However, from the viewpoint of production efficiency of the laminated glass 10, it is favorable that the distance between the outer periphery of the infrared-reflective film 5 and the outer periphery of the laminated glass 10 is made to be the same as the distance W in the visible area on the left side (the front side), the right side (the rear side), and the lower side of the laminated glass 10 as the invisible area below the belt line VL. Specifically, it is favorable that the distances are set to the distance w1 on the left side, the distance w2 on the right side of the laminated glass 10 in the invisible area, and a distance w4 on the lower side which is virtually equivalent to w1 and w2.

As for the requirement of (5), it is favorable that the infrared-reflective film 5 has a minimum radius of curvature of greater than or equal to 8 mm in the visible area of the laminated glass 10. In the visible area of the laminated glass 10, every corner of the outer periphery is normally shaped to have a curvature in plan view. Similarly, in the visible area of the laminated glass 10, every corner of the outer periphery of the infrared-reflective film 5 is shaped to have a curvature in plan view. In the infrared-reflective film 5 illustrated in FIG. 1, a point at which the outer periphery has the minimum radius of curvature is a point A at the corner formed by the upper side and the right side (the rear side). In front view, if there is a part along the outer periphery of the infrared-reflective film 5 where the radius of curvature is less than 8 mm, the design may be impaired due to a sharp reflection of light at the part. The minimum radius of curvature of the outer periphery of the infrared-reflective film 5 is favorably greater than or equal to 10 mm, and more favorably greater than or equal to 15 mm.

### [Adhesive Layers]

The first adhesive layer 3 and the second adhesive layer 4 in the door glass 10 have the same shape and the same dimensions as the principal surfaces of the first glass plate 1 and the second glass plate 2, and are flat film-like layers having a thickness that will be described later. The first adhesive layer 3 and the second adhesive layer 4 are inserted between the first glass plate 1 and the second glass plate 2 while sandwiching the infrared-reflective film 5 in-between, and have a function of bonding these together to be integrated as the door glass 10.

The first adhesive layer 3 and the second adhesive layer 4 may have the same configuration, except for the arrangement positions in the door glass 10. In the following, the first adhesive layer 3 and the second adhesive layer 4 are collectively referred to as the “adhesive layer(s)” in the following description.

The adhesive layer is formed as an adhesive layer containing a thermoplastic resin used in an adhesive layer of a normal laminated glass. The type of thermoplastic resin is not limited in particular and may be suitably selected from among the known thermoplastic resins that can form an adhesive layer.

As the thermoplastic resin, polyvinyl acetal such as polyvinyl butyral (PVB), polyvinyl chloride (PVC), saturated polyester, polyurethane, ethylene-vinyl acetate copolymer (EVA), ethylene-ethyl acrylate copolymer, cycloolefin polymer (COP), and the like may be listed. One of the thermoplastic resins may be used alone or two or more types may be used in combination.

The thermoplastic resin is selected taking into account the balance of various performances including glass transition point, transparency, weather resistance, adhesion, penetration resistance, shock energy absorption, moisture resistance, heat insulation, and the like. The glass transition point of a thermoplastic resin can be adjusted, for example, by the amount of a plasticizer. Taking into account the balance of the various performances described above, the thermoplastic resin used for the adhesive layer is favorably PVB, EVA, polyurethane, or the like. Further, in consideration of reducing deformation of the infrared-reflective film 5 while manufacturing the door glass 10, PVB is particularly favorable.

The adhesive layer contains a thermoplastic resin as the main component. The adhesive layer containing a thermoplastic resin as the main component means that the content of the thermoplastic resin with respect to the total amount of the adhesive layer is greater than or equal to 30 mass %. The adhesive layer may contain one or more of various additives including an infrared absorber, an ultraviolet absorber, a fluorescent agent, an adhesion control agent, a coupling agent, a surfactant, an antioxidant, a heat stabilizer, a light stabilizer, a dehydrating agent, a defoaming agent, an antistatic agent, a flame retardant, and the like.

It is favorable that the adhesive layer has a thermal shrinkage rate of greater than or equal to 2.0% and less than or equal to 8.0% in the direction in which the thermal shrinkage rate becomes maximum (hereafter, referred to as the “maximum shrinkage direction” as in the case of the infrared-reflective film), and a thermal shrinkage rate of greater than or equal to 2.0% and less than or equal to 8.0% in a direction perpendicular to the maximum direction (hereafter, simply referred to as the “orthogonal direction”). The thermal shrinkage rate in the maximum shrinkage direction in the adhesive layer is more favorably greater than or equal to 4.0% and less than or equal to 7.0%, and the thermal shrinkage rate in the orthogonal direction is more favorably greater than or equal to 4.0% and less than or equal to 7.0%.

However, the thermal shrinkage rate of the adhesive layer is a shrinkage rate of the length in a predetermined direction before and after the heat treatment, where “before the heat treatment” is defined as a point in time when the adhesive layer has been left in an environment of constant temperature and constant humidity at a temperature of 20° C. and a humidity of 55% for more than 24 hours; and “after the heat treatment” is defined as a point in time thereafter when the adhesive layer has been held at 50° C. for 10 minutes, and cooled in a desiccator at 20° C. for 1 hour. Specifically, the thermal shrinkage rate of an adhesive layer can be measured in the same way as in the method of measuring the thermal shrinkage rate of an infrared-reflective film, except that the temperature and test time of the heat treatment are changed to 50° C. and 10 minutes, and a preprocess and a postprocess are applied before and after the heat treatment.

Similar to the infrared-reflective film 5, the adhesive layer is manufactured by stretching the constituent material into a film shape, and thereby, in the MD direction, which is the flow direction during the manufacturing, the residual stress is greater, and the adhesive layer tends to be thermally shrunk more easily. Therefore, normally, the MD direction corresponds to the maximum shrinkage direction, and the TD direction as the width direction corresponds to the orthogonal direction. In the case of matching the maximum shrinkage direction of the infrared-reflective film 5 with the maximum shrinkage direction of the adhesive layer when laminating the layers during the manufacture of the door glass 10, the load of deformation tends to be posed on the infrared-reflective film 5.

Therefore, in the door glass 10, the adhesive layer is favorably arranged such that the maximum shrinkage direction of the infrared-reflective film 5 is orthogonal to the maximum shrinkage direction of the adhesive layer. Although it is favorable that the adhesive layer and the infrared-reflective film are completely orthogonal to each other with respect to the maximum shrinkage directions, it is sufficient that the difference of the angles from the completely orthogonal state falls within ±5° for the adhesive layers.

Also, in the door glass 10, it is favorable that a value (H) obtained by dividing the thermal shrinkage rate in the direction in which the thermal shrinkage rate of the infrared-reflective film 5 is maximum, by an average of the thermal shrinkage rates of the first adhesive layer 3 and the second adhesive layer 4 in the respective maximum directions, is within a range of greater than or equal to 0.1 and less than or equal to 0.4. In the case of the numerical value H being greater than or equal to 0.1, the load of deformation posed on the infrared-reflective film due to the shrinkage of the adhesive layers is reduced, and the degraded appearance of orange peel and/or wrinkles is less likely to occur. In the case of the numerical value H being less than or equal to 0.4, the respective directions of the maximum thermal shrinkage rates of the adhesive layers and the infrared-reflective film do not come too close to the matching direction; therefore, the shrinkage of the infrared-reflective film is not accelerated, and the degraded appearance caused by the drawing by the infrared-reflective film is less likely to occur.

The thicknesses of the first adhesive layer 3 and the second adhesive layer 4 are not limited in particular. Specifically, similar to an adhesive layer commonly used for a laminated glass for vehicles or the like, it is favorable that each of the thicknesses is favorably 0.3 mm to 0.8 mm, and the total thickness of the first adhesive layer 3 and the second adhesive layer 4 is favorably 0.7 mm to 1.5 mm. If the thickness of each of the adhesive layers is less than 0.3 mm or the total thickness of the two layers is less than 0.7 mm, the strength of the two layers may be insufficient; conversely, if the thickness of each adhesive layer exceeds 0.8 mm or the total thickness of the two layers exceeds 1.5 mm, a so-called plate displacement phenomenon may occur, which is a phenomenon where displacement occurs between the first glass plate 1 and the second glass plate 2 that have the adhesive layers sandwiched in-between, during a bonding (pressure joining) step in an autoclave when manufacturing the door glass 10, which will be described later.

The adhesive layer is not limited to a single-layer structure. For example, a multi-layer resin film that includes laminated resin films having different properties (having different loss tangent), which is disclosed in Japanese Unexamined Patent Application Publication No. 2000-272936, to be used for the purpose of improving the sound insulation performance, may be used as the adhesive layer. Further, in the door glass 10, the adhesive layer may be designed so that the cross-sectional shape in the vertical direction is a wedge shape. As the wedge shape, the thickness of the adhesive layer may be monotonically reduced from the upper side to the lower side, may be designed to have a part in which the thickness is partially uniform as long as the thickness on the upper side is greater than the thickness on the lower side, or the wedge angle may be changed partially.

### [Glass Plates]

Although the thicknesses of the first glass plate 1 and the second glass plate 2 in the door glass 10 vary depending on the composition and the compositions of the first adhesive layer 3 and the second adhesive layer 4, it is generally 0.1 to 10 mm.

Among the first glass plate 1 and the second glass plate 2, for example, in the case of arranging the first glass plate 1 on the interior side of a vehicle, the thickness of the first glass plate 1 is favorably 0.5 to 2.0 mm, and more favorably 0.7 to 1.8 mm. In this case, it is favorable that the thickness of the second glass plate 2 on the exterior side of the vehicle is greater than or equal to 1.6 mm because the stone-chip resistance becomes satisfactory. The difference in thickness between the two is favorably 0.3 mm to 1.5 mm, and more favorably 0.5 mm to 1.3 mm. The thickness of the second glass plate 2 on the exterior side of the vehicle is favorably 1.6 mm to 2.5 mm, and more favorably 1.7 mm to 2.1 mm.

From the viewpoint of weight reduction, it is favorable that the total plate thickness of the first glass plate 1 and the second glass plate 2 is less than or equal to 4.1 mm, more favorably less than or equal to 3.8 mm, and further favorably less than or equal to 3.6 mm.

Note that it is favorable that the first glass plate 1 and second glass plate 2 have their end surfaces chamfered as illustrated in FIG. 2. Chamfering can be performed by a conventional method. The chamfering of the glass plates makes them practical from the viewpoints of both design and safety in glass handling.

The first glass plate 1 and the second glass plate 2 may be formed of inorganic glass or organic glass (resin). As the inorganic glass, conventional soda-lime glass (also called soda-lime silicate glass), alumino silicate glass, borosilicate glass, alkali-free glass, quartz glass, and the like may be listed. Among these, soda-lime glass is particularly favorable. As the inorganic glass, for example, float plate glass molded by a float process or the like may be considered. As the inorganic glass, strengthened glass to which chemical strengthening, thermal strengthening, or the like is applied may be used.

As the organic glass (resin), polycarbonate resin, polystyrene resin, aromatic polyester resin, acrylic resin, polyester resin, polyarylate resin, polycondensate of halogenated bisphenol A and ethylene glycol, acrylic urethane resin, halogenated aryl group-containing acrylic resin, and the like may be listed. Among these, polycarbonate resin such as aromatic polycarbonate resin, and acrylic resin such as polymethylmethacrylate-based acrylic resin are is favorable, and polycarbonate resin is more favorable. Further, among the polycarbonate resins, bisphenol A-based polycarbonate resin is particularly favorable. Note that two or more types of resins described above may be used together.

The glass may contain an infrared absorber, an ultraviolet absorber, and the like. As such glass, green glass, UV absorbing (UV) green glass, and the like may be listed. Note that UV green glass contains SiO₂ by greater than or equal to 68 mass % and less than or equal to 74 mass %; Fe₂O₃ by greater than or equal to 0.3 mass % and less than or equal to 1.0 mass %; and FeO by greater than or equal to 0.05 mass % and less than or equal to 0.5 mass %, has an ultraviolet transmittance at 350 nm of less than or equal to 1.5%, and has the minimum value of the transmittance in a region greater than or equal to 550 nm and less than or equal to 1700 nm.

The glass simply needs to be transparent, which may be colorless or colored. Also, the glass may have two or more layers laminated. Although depending on the application, inorganic glass is favorable.

Although the materials of the first glass plate 1 and second glass plate 2 may the same or may be different, it is favorable to be the same. The shapes of the first glass plate 1 and the second glass plate 2 may be flat or may have a curvature on the entire surface or in part. The surfaces of the first glass plate 1 and the second glass plate 2 exposed to the atmosphere may be coated to give a water-repellent function, a hydrophilic function, an anti-fouling function, and the like. Also, the facing surfaces of the first glass plate 1 and the second glass plate 2 may be normally applied with coating that includes a metal layer such as a low-radioactivity coating, an infrared-insulation coating, a conductive coating, and the like.

### [Laminated Glass]

It is favorable that a laminated glass constituting a door glass according to the present invention has a visible light reflectance of greater than or equal to 7% and less than or equal to 10% on the exterior side of the vehicle.

If the visible light reflectance (Rv) of the laminated glass 10 measured on the exterior side of the vehicle is less than 7%, the infrared-reflective film 5 may not function sufficiently, namely, the heat insulation capability may not be sufficient. If the visible light reflectance (Rv) is greater than 10%, the shimmer caused by the end surfaces of the infrared-reflective film is conspicuous at the end parts of the laminated glass. The visible light reflectance (Rv) is more favorably greater than or equal to 7.5% and less than or equal to 10.0%.

It is favorable that the laminated glass 10 has a solar transmission (Te) of less than or equal to 45% and a visible light transmission (Tv) of greater than or equal to 70%. The solar transmittance (Te) is more favorably less than or equal to 40%, and particularly favorably less than or equal to 38%. The solar reflectance (Re) measured on the exterior side of the vehicle is more favorably greater than or equal to 18%, and particularly favorably greater than or equal to 20%. The visible light transmittance (Tv) is more favorably greater than or equal to 72%, and particularly favorably greater than or equal to 73%. Also, the haze value of the laminated glass 10 is favorably less than or equal to 1.0%, more favorably less than or equal to 0.8%, and particularly favorably less than or equal to 0.6%.

Note that the visible light reflectance (Rv) measured on the exterior side of the vehicle; the solar reflectance (Re) measured on the exterior side of the vehicle; the solar transmittance (Te); and the visible light transmittance (Tv) are values obtained by measuring transmittances and reflectances in a wavelength range including at least 300 to 2100 nm by a spectrophotometer or the like, and performing calculation from formulas specified in JIS R3106 (1998) and JIS R3212 (1998), respectively. In the present description, unless otherwise noted, a visible light reflectance, a solar reflectance, a solar transmittance, and a visible light refer to the visible light reflectance (Rv) measured on the exterior side of the vehicle; the solar reflectance (Re) measured on the exterior side of the vehicle; the solar transmittance (Te); and the visible light transmittance (Tv) as measured and calculated by the method described above.

Further, it is favorable that the color tone of reflected light, which is obtained by irradiating the laminated glass 10 with light from a D65 light source on the exterior side of the vehicle at an angle of incidence of 10 to 60 degrees, is −5<a*<3 and −12<b*<2 in terms of the CIE 1976 L*a*b* chromaticity coordinates. If values of a* and b* measured under the above conditions are out of the respective ranges, the shimmer at the end parts of the laminated glass caused by the end surfaces of the infrared-reflective film tends to be conspicuous. Here, a* measured under the above conditions is more favorably −3*a′<2. Also, b* measured under the above conditions is more favorably −9<b′<0.

### [Manufacture of Door Glass]

A door glass according to the present invention can be manufactured according to commonly known techniques. When manufacturing a door glass (laminated glass) 10, a laminated glass precursor as a laminated glass before pressure joining is prepared, in which a first glass plate, a first adhesive layer, an infrared-reflective film, a second adhesive layer, and a second glass plate that have been prepared as described above are laminated in this order. At this time, the above components are laminated so that the positional relationship between the outer periphery of the laminated glass to be obtained and the outer periphery of the infrared-reflective film in front view satisfies the requirement of (3). Also, if necessary, the TD directions and the MD directions of the first adhesive layer, the infrared-reflective film, and the second adhesive layer are set to the favorable direction described above when laminating the components.

The laminated glass precursor is placed in a vacuum bag, for example, like a rubber bag; then, the vacuum bag is connected to an exhaust system, and while the vacuum bag is being sucked to reduce the pressure (degassed) so that the pressure in the vacuum bag is reduced by approximately −65 to −100 kPa (absolute pressure is approximately 36 to 1 kPa) and heated up to a temperature at approximately 70 to 110° C. Thus, a laminated glass is obtained in which all of the first glass plate, the first adhesive layer, the infrared-reflective film, the second adhesive layer, and the second glass plate are bonded together. Thereafter, if necessary, the laminated glass is placed in an autoclave to perform pressure joining that applies heat and pressure under conditions of a temperature at approximately 120 to 150° C. and a pressure of approximately 0.98 to 1.47 MPa. The pressure joining further improves the durability of the laminated glass.

### EXAMPLES

In the following, the present invention will be described in further detail with application examples. Note that the present invention is not limited to the application examples described below. First, nine types of infrared-reflective films A to I were manufactured by the following methods. The infrared-reflective films A to H are constituted with a laminate that has two types of resin layers having different refractive indices laminated, each of which has a different thermal shrinkage rate. The infrared-reflective film I is an infrared-reflective film that has two types of resin layers having different refractive indices laminated on a PET film.

### (Manufacture of Infrared-Reflective Films a to H)

A resin A and a resin B were used as two types of thermoplastic resins having different refractive indices. As the resin A, a PET (crystalline polyester, melting point at 255° C.) having an intrinsic viscosity IV=0.65 and a refractive index of 1.66 was used. As the resin B, a PET copolymer (PE/SPG.T/CHDC) having an intrinsic viscosity IV=0.73 and a refractive index of 1.55, and containing 25 mol % of spiroglycol units and 30 mol % of cyclohexanedicarboxylic acid units with respect to all units, was used. The two types of prepared resins were melted at 280° C. in respective extruders, 2000 layers were alternately laminated in the thickness direction so as to have an optical thickness ratio of (resin A/resin B)=1, to obtain an unstretched laminate.

For each of the infrared-reflective films A to H, the unstretched laminate was biaxially stretched by predetermined stretching factors, the thickness of the laminate was adjusted, and then, heat treatment was applied to adjust the residual stress (thermal shrinkage rate) in the MD direction and in the TD direction; in this way, infrared-reflective films having the respective physical properties (thermal shrinkage rates and thickness) listed in Table 1 were obtained. In a field of “thermal shrinkage rates” shown in Table 1, the “maximum direction” corresponds to a direction in which the thermal shrinkage rate becomes maximum, specifically, the MD direction of an infrared-reflective film. The “orthogonal direction” shown in Table 1 is a direction perpendicular to the “maximum direction”, which is the TD direction of the infrared-reflective film. Note that the thermal shrinkage rate of an infrared-reflective film is a shrinkage rate of the length in a predetermined direction before and after holding the infrared-reflective film at 150° C. for 30 minutes, and a value was measured by the method described above.

### (Manufacture of Infrared-Reflective Film I)

On a PET film having a thickness of 100 μm, by using a magnetron sputtering method, Nb₂O₅ layers as high-refractive-index dielectric layers and SiO₂ layers as low-refractive-index dielectric layers are alternately laminated in this order by seven layers in total to form an infrared-reflective film to be served as the infrared-reflective film I.

### Examples 1 to 14

Laminated glasses, which have the same laminate configuration as the laminated glass illustrated in FIG. 2, w1=w2 in each example, and w1 (w2) differs in the examples, were manufactured and evaluated as follows. Examples 1 to 8 are application examples and Examples 9 to 14 are comparative examples.

### (Manufacture of Laminated Glasses)

As the first glass plate, a heat-absorbing green glass (manufactured by Asahi Glass Co., Ltd., commonly known as NHI) having an outer periphery size of 500 mm in length and 950 mm in width, and a plate thickness of 2 mm was prepared; and as a second glass plate, a clear glass (manufactured by Asahi Glass Co., Ltd, commonly known as FL) having an outer periphery size of 500 mm in length and 950 mm in width, and a plate thickness of 2 mm was prepared.

As the first adhesive layer, a PVB film having a thickness of 0.76 mm (manufactured by Eastman Chemical Co., product number QL51) was used; as the second adhesive layer, a PVB film having a thickness of 0.38 mm (manufactured by Eastman Chemical Co., product number RK11) was used; and the outer periphery size of each of the adhesive layers was 500 mm in length and 950 mm in width, which are the same as in the first glass plate and the second glass plate. Note that in both of the two types of PVB films having different thicknesses, the thermal shrinkage rate in the direction in which the thermal shrinkage rate becomes maximum, specifically, the thermal shrinkage rate in the MD direction was 6.0%; and the thermal shrinkage rate in the orthogonal direction, specifically, the thermal shrinkage rate in the TD direction was 5.0%. Also, a thermal shrinkage rate of a PVB film is a value of the PVB film as measured by the method described above. Further, by adjusting the stretching method, two types of adhesive layers having different thermal shrinkage rates were prepared. In both cases, the first adhesive layer was made as a PVB film having a thickness of 0.76 mm, and the second adhesive layer was made as a PVB film having a thickness of 0.38 mm. One of the adhesive layers had a thermal shrinkage rate in the MD direction of 8.5% and a thermal shrinkage rate in the TD direction of 7.0%. The other one of the adhesive layers had a thermal shrinkage rate in the MD direction of 2.5% and a thermal shrinkage rate in the TD direction of 2.0%.

In each of Examples, by using one of the infrared-reflective films A to I obtained as described above, a laminate having the first glass plate, the first adhesive layer, the infrared-reflective film, the second adhesive layer, and the second glass plates laminated in this order, was prepared.

Note that in each of Examples, the size of the infrared-reflective films A to I was adjusted so that the distance (w1) between the outer periphery of the infrared-reflective films A to I and the outer periphery of the first glass plate and the second glass plate in front view, took values listed in Table 1 on all four sides. Also, all of the first adhesive layer, the infrared-reflective film, and the second adhesive layer were laminated by having the MD direction correspond to the lateral direction of the first glass plate and the second glass plate.

The laminate was placed in a vacuum bag, which was degassed so that the indication of the pressure gauge became less than or equal to 100 kPa; and then, the laminate was heated up to 120° C., pressure-joined, and further heated and pressurized in an autoclave at 135° C. and 1.3 MPa for 60 minutes; finally, the laminate was cooled to be a laminated glass.

For each laminated glass obtained in each of Examples, the visible light reflectance (Rv); the solar reflectance (Re); and a* and b* in the CIE 1976 L′a′b″ chromaticity coordinates of reflected light obtained by irradiating the laminated glass with light emitted by a D65 light source from the exterior side of the vehicle at an angle of incidence of 10 degrees, were measured. Note that a spectrophotometer (U4100 manufactured by Hitachi High-Technology) was used for the measurement. The results are shown in Table 1.

### [Evaluation]

The obtained laminated glass was evaluated with respect to the degradation of the end parts of the infrared-reflective film, the drawing of the adhesive layers, the shimmer, the orange peel, and the heat insulation.

### <Degradation of the End Parts of the Infrared-Reflective Film>

The laminated glass was charged into a thermo-hygrostat at a temperature of 80° C. and a humidity of 95% (RH), and after 1000 hours, the presence or absence of discoloration at the end parts of the infrared-reflective film was visually observed. In addition, the presence or absence of cracking within a range inward from the outer periphery of the infrared-reflective film by less than or equal to 20 mm was confirmed by microscopic observation. The evaluation was performed according to the following criteria.

A; both discoloration and cracking were not observed at the end parts of the infrared-reflective film.
C; one of discoloration and cracking was observed at the end parts of the infrared-reflective film.

### <Drawing of Adhesive Layers>

Visual observation was made, in front view, whether the outer periphery of the adhesive layers was drawn inward from the outer periphery of the laminated glass, and whether the outer periphery of the infrared-reflective film was drawn inward from the corresponding position of the laminate before pressure joining. The evaluation was performed according to the following criteria.

A; No drawing was observed for both of the infrared-reflective film and the adhesive layers.
C; a drawn part over a length of greater than or equal to 5 mm was observed along the outer periphery of the adhesive layers and the outer periphery of the infrared-reflective film.

A value obtained by dividing the thermal shrinkage rate in the direction in which the thermal shrinkage rate of the infrared-reflective film 5 is maximum, by an average of the thermal shrinkage rates of the first adhesive layer and the second adhesive layer in the respective maximum directions is calculated as the “thermal shrinkage rate (H)”, and the results are summarized in Table 1.

### <Shimmer; Change in Color Tone>

The laminated glass was assembled to be a door glass, and put into a state of, for example, being attached to a vehicle as illustrated in FIG. 3, to visually observe the shimmer at the end parts of the door glass (change in the color tone) from the interior side of the vehicle. The laminated glass was shaped as illustrated in FIG. 1. The evaluation was performed according to the following criteria. A; regardless of the door glass being moved up or down, no change in the color tone was observed at the end parts of the door glass.

B; only when the door glass was moved up or down (when being actuated), change in the color tone was observed at the end parts of the door glass.
C; regardless of the door glass being moved up or down, change in the color tone was observed at the end parts of the door glass.

### <Orange Peel>

The laminated glass was placed horizontally in a state where the background was darkened; further, a straight-tube-shaped fluorescent lamp (630 mm in length, 30 W, FL30SW manufactured by Mitsubishi Electric Lighting Co., Ltd.) was installed 180 cm above the laminated glass so that the length direction corresponded to the width direction of the laminated glass, and turned on. The position of the fluorescent lamp was adjusted to come right above the center part of the laminated glass, to visually observe whether the outline of a reflected image of the fluorescent lamp fluctuates in the center part. Similarly, the position of the fluorescent lamp was adjusted to come right above the vicinity of the lower side of the laminated glass, to visually observe whether the outline of a reflected image of the fluorescent lamp fluctuates in the vicinity of the lower side. Observation results were evaluated according to the following criteria.

A; no fluctuation was observed in the outline of the reflected image of the fluorescent lamp.
B; fluctuation was observed in part of the outline of the reflected image of the fluorescent lamp at the center part or in the vicinity of the lower side. C; fluctuation was observed in approximately half of the outline of the reflected image of the fluorescent lamp at the center part and in the vicinity of the lower side.

### <Heat Insulation>

The solar reflectance Re of the laminated glass measured above was used as an indicator of the heat insulation. All values of the solar reflectance were greater than or equal to 20%, which indicated good performance.

### <Design of Corners of Door Glass>

Laminated glasses having a shape in front view as illustrated in FIG. 1 were prepared. In total, three types of laminated glasses were prepared in which the respective radii of curvature of the infrared-reflective film at the point A, at which the outer periphery has the minimum radius of curvature, are 16 mm, 9 mm, and 7 mm, respectively. The infrared-reflective film of Example 2 was used for the laminated glasses having the radii of curvature of 16 mm and 9 mm at the point A, and the infrared-reflective film of Example 3 was used for the laminated glass having the radius of curvature of 7 mm at the point A. Each of the laminated glasses was placed under a fluorescent lamp and the appearance of the infrared-reflective film at the point A was visually observed. As a consequence, in the case of the radii of curvature at the point A being 16 mm and 9 mm, intense reflection of light was not observed, and the design was at a level of no problem. On the other hand, in the case of the radius of curvature at the point A being 7 mm, intense reflection of light was observed, and the design was inferior.

TABLE 1

| | | | | | | Properties | | | | | | | | | | |
|---|---|---|---|---|---|---|---|---|---|---|---|---|---|---|---|---|
| | Requirements for | | | | | of adhesive | | | | | | | | | | |
| | IR reflective film | | | | | layer | | | | | | | | | | |
| | | Thermal | | | | Thermal | | | | | | | | | | |
| | | shrinkage | | | | shrinkage | | Ratio | Properties of | | | | | | | |
| | | rates | | | | rates | | between | laminated glass | | | | | | | |
| | | Maxi- | Or- | | | Maxi- | Or- | thermal | | | Reflected | | Evaluation | | | |
| | | mum | thogonal | Thick- | | mum | thogonal | shrinkage | | | color | | Deg- | Adhesive | | |
| | | direc- | direc- | ness | w1 | direc- | direc- | rates | Rv | Re | (10°) | | rada- | layer | | Orange |
| Ex. | Type | tion | tion | [μm] | [mm] | tion | tion | (H) | [%] | [%] | a* | b* | tion | drawing | Shimmer | peel |
| 1 | A | 0.7% | 0.7% | 103 | 0 | 6.0% | 5.0% | 0.12 | 7.9 | 22.4 | 1.4 | −8.5 | A | A | A | A |
| 2 | B | 0.8% | 0.8% | 103 | 0 | 6.0% | 5.0% | 0.13 | 7.9 | 22.5 | 1.5 | −8.4 | A | A | A | A |
| 3 | C | 1.1% | 1.1% | 104 | 0 | 6.0% | 5.0% | 0.18 | 8.0 | 23.0 | 1.5 | −8.3 | A | A | A | A |
| 4 | B | 0.8% | 0.8% | 103 | 10 | 6.0% | 5.0% | 0.13 | 7.9 | 22.5 | 1.5 | −8.4 | A | A | A | A |
| 5 | D | 0.8% | 0.8% | 103 | 10 | 6.0% | 5.0% | 0.13 | 11.1 | 22.7 | 1.5 | −7.8 | A | A | B | B |
| 6 | E | 0.8% | 0.8% | 103 | 10 | 6.0% | 5.0% | 0.13 | 7.9 | 22.6 | 4.1 | 3.7 | A | A | B | B |
| 7 | B | 0.8% | 0.8% | 103 | 0 | 8.5% | 7.0% | 0.09 | 7.9 | 22.5 | 1.5 | −8.4 | A | A | A | B |
| 8 | C | 1.1% | 1.1% | 104 | 0 | 2.5% | 2.0% | 0.44 | 8 | 23.0 | 1.5 | −8.3 | A | B | A | A |
| 9 | F | 0.6% | 0.6% | 102 | 0 | 6.0% | 5.0% | 0.10 | 7.9 | 22.4 | 1.5 | −8.4 | A | A | A | C |
| 10 | G | 1.2% | 1.2% | 105 | 0 | 6.0% | 5.0% | 0.20 | 8.1 | 22.7 | 1.4 | −8.6 | A | C | A | A |
| 11 | H | 2.0% | 2.0% | 108 | 0 | 6.0% | 5.0% | 0.33 | 8.0 | 21.9 | 1.4 | −8.5 | A | C | A | A |
| 12 | B | 0.8% | 0.8% | 103 | 20 | 6.0% | 5.0% | 0.13 | 7.9 | 22.5 | 1.5 | −8.4 | A | A | C | A |
| 13 | B | 0.8% | 0.8% | 103 | 30 | 6.0% | 5.0% | 0.13 | 7.9 | 22.5 | 1.5 | −8.4 | A | A | C | A |
| 14 | I | 0.8% | 0.8% | 103 | 0 | 6.0% | 5.0% | 0.13 | 8.1 | 21.7 | 1.6 | −8.5 | C | A | A | B |

1. A door glass for a vehicle comprising:
a laminated glass having a first glass plate, a first adhesive layer, an infrared-reflective film, a second adhesive layer, and a second glass plate laminated in this order,
wherein the infrared-reflective film includes a laminate in which 100 or more layers of resin layers having different refractive indices are laminated,
wherein the infrared-reflective film has a thermal shrinkage rate of greater than 0.6% and less than 1.2% in a direction in which the thermal shrinkage rate becomes maximum, and a thermal shrinkage rate of greater than 0.6% and less than 1.2% in a direction perpendicular to the direction in which the thermal shrinkage rate becomes maximum,
wherein the thermal shrinkage rate of the infrared-reflective film in a predetermined direction is a shrinkage rate of a length in the predetermined direction before and after holding the infrared-reflective film at 150° C. for 30 minutes, and
wherein in an area where the laminated glass is visible when the laminated glass is mounted on the vehicle, an outer periphery of the infrared-reflective film is positioned within a range of up to 10 mm inward from an outer periphery of the laminated glass in front view.

2. The door glass for the vehicle as claimed in claim 1, wherein a visible light reflectance of the laminated glass measured on an exterior side of the vehicle is greater than or equal to 7% and less than or equal to 10%.

3. The door glass for the vehicle as claimed in claim 1, wherein a color tone of reflected light obtained by irradiating the laminated glass 10 with light from a D65 light source on an exterior side of the vehicle at an angle of incidence of 10 to 60 degrees is −5<a*<3 and −12<b*<2 in terms of CIE 1976 L*a*b* chromaticity coordinates.

4. The door glass for the vehicle as claimed in claim 1, wherein in an area where the laminated glass is visible when the laminated glass is mounted on the vehicle, an outer periphery of the infrared-reflective film is arranged to be positioned within a range of up to 5 mm inward from an outer periphery of the laminated glass in front view.

5. The door glass for the vehicle as claimed in claim 1, wherein in an area where the laminated glass is visible when the laminated glass is mounted on the vehicle, every corner of an outer periphery of the infrared-reflective film in front view has a curvature, and a minimum radius of curvature of the outer periphery is greater than or equal to 8 mm.

6. The door glass for the vehicle as claimed in claim 1, wherein the infrared-reflective film has a thickness of less than or equal to 120 μm.

7. The door glass for the vehicle as claimed in claim 1, wherein the infrared-reflective film is formed by alternately laminating two types of resin layers having different refractive indices, wherein resins forming the resin layers include at least one type selected from among a polyethylene terephthalate and a polyethylene terephthalate copolymer.

8. The door glass for the vehicle as claimed in claim 1, wherein the first adhesive layer and the second adhesive layer have a thermal shrinkage rate of greater than or equal to 2% and less than or equal to 8% in a direction in which the thermal shrinkage rate becomes maximum, and a thermal shrinkage rate of greater than or equal to 2% and less than or equal to 8% in a direction perpendicular to the direction in which the thermal shrinkage rate becomes maximum,
wherein the thermal shrinkage rate of the thermal shrinkage rate of the first adhesive layer and the second adhesive layer in a predetermined direction is a shrinkage rate of a length in the predetermined direction before and after holding the first adhesive layer and the second adhesive layer at 50° C. for 10 minutes, and
wherein the direction in which the thermal shrinkage rate of the infrared-reflective film becomes maximum is orthogonal to the direction in which the thermal shrinkage rate of the first adhesive layer and the second adhesive layer becomes maximum.

9. The door glass for the vehicle as claimed in claim 1, wherein the first adhesive layer and the second adhesive layer contain polyvinyl butyral.

10. The door glass for the vehicle as claimed in claim 1, wherein a value obtained by dividing the thermal shrinkage rate in the direction in which the thermal shrinkage rate of the infrared-reflective film becomes maximum, by an average of the thermal shrinkage rates of the first adhesive layer and the second adhesive layer in respective maximum directions, is within a range of greater than or equal to 0.1 and less than or equal to 0.4.
